(19) United States
(12) Patent Application Publication
(10) Pub. No.: US 2006/0169737 A1
(43) Pub. Date: Aug. 3, 2006

(54) Positionoing device for electric nailers

(76) Inventor: Wen-Sheng Huang, Tali City (TW)

Correspondence Address: PHILLIP LIU, 6980, WHITEOAK DR., RICHMOND, BC, V7EAZ9, CA

(21) Appl. No.: 11/045,356

(22) Filed: Jan. 31, 2005

(51) Int. Cl. B25C 5/06

(52) U.S. Cl. 227/119; 227/136

(57) ABSTRACT

A positioning device for an electric nailer which comprises a case which is movably received in a barrel composed of two side walls. A driving member is received in the case and includes two disks on two ends of a shaft. Each disk has a plurality of teeth extending radially outward from an outer periphery thereof so as to be engaged with and to drive a nail chain. A crank member extends through the driving member. One of the disks has at least one recess defined in an outside thereof and a spring and a bead are respectively received in the at least one recess. The second part has a plurality of positioning dents defined in an inside thereof so that the bead is engaged with one of the dents when the driving member rotates.

### FIELD OF THE INVENTION

The present invention relates to a device for positioning the driving member so as to precisely align nails with the outlet of the nailer.

### BACKGROUND OF THE INVENTION

A conventional positioning device for controlling the driving member at desired position so that the nail chain driven by the driving member is positioned before being fired. As shown in FIG. 13, the conventional positioning device 90 includes a first part 901 and a second part 902, and a driving member 91 is received in between the first part 901 and the second part 902. The driving member 91 is an I-shaped member with two gear disks 913 on two ends of the shaft of the driving member 91, a positioning disk 911 is connected to one of the two gear disks 913. Each gear disk 913 has a plurality of teeth 912 extending radially from an outer periphery thereof so as to be engaged with the nail chain which is not shown. A first driving piece 92 and a second driving piece 93 are received in a central passage 914 defined through the driving member 91. The first driving piece 92 includes a rectangular hole 921 through which a first protrusion 96 of a crank member 94 securely extends. The positioning disk 911 is engaged with a resilient plate 95 which has an engaging end for removably engaged one of the recesses between the teeth of the positioning disk 911.

When pushing a safety link (not shown) of the nailer against an object, a second protrusion 941 of the crank member 94 is moved along a slot of the nailer till it is stopped by an end of the inside of the slot. The movement of the crank member 94 also rotates the driving member 91 and the positioning disk 911 rotates over the engaging end of the resilient member 95 until the engaging end is engaged with the next recess. The nail chain is then moved upward so as to align one nail with the outlet of the nailer and the nail can be nailed into the object by the power bit of the nailer. After the nail is nailed into the object, and the user removes the safety link from the object, a spring connected to the positioning device 90 pushes the positioning device 90 which is pivoted an angle to its ready-to-fire position.

The gear disk 911 needs a lot of machining processes which are time-consuming and expensive. Besides, the resilient member 95 tends to be fatigue after a period of use and this affects the positioning of the driving member 91.

The present invention intends to provide a positioning device for positioning the driving member and no complicated gear disk is required.

### SUMMARY OF THE INVENTION

The present invention relates to a positioning device for an electric nailer and comprises a case composed of a first part and a second part, an end of the case movably received in a barrel composed of two side walls, and a driving member received between the first part and the second part. The driving member includes two disks on two ends of a shaft of the driving member and each disk has a plurality of teeth extending radially outward from an outer periphery thereof so as to drive a nail chain. One of the disks has at least one recess defined in an outside thereof, a spring and a bead are respectively received in the at least one recess. The second part has a plurality of positioning dents defined in an inside thereof so that the bead is engaged with one of the dents. A crank member has a first protrusion extending through a first hole in the first part, a one-direction bearing in a central passage defined through the driving member, and a second hole defined through the second part. The dents are located around the second hole. A spring is biased between the case and the barrel.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1-1 is an exploded view to show the positioning device of the present invention;

FIG. 1-2 is a cross sectional view to show the bead in the at least one recess in the driving member is engaged with one of the dents in the case;

FIG. 2 is a perspective view to show the case with the driving member received therein;

FIG. 3 shows the case movable received in the barrel and the safety link is connected to the case;

FIG. 4 is a side view to show the chain engaged with the driving member;

FIG. 5 shows that the safety link is pushed against an object and the second protrusion of the crank member is moved along the L-shaped hole in the barrel at position C1;

FIG. 6 shows that the nail chain is driven to align one nail with the ring of the safety link when the second protrusion of the crank member is moved to the lowest position C2 in the L-shaped hole in the barrel;

FIG. 7 shows the nail is nailed into the object by a power bit in the nailer and the second protrusion is moved to position C3;

FIG. 8 shows that the safety link is removed from the object and the second protrusion moves to position C4;

FIGS. 9 to 12 show another embodiment of the present invention wherein the L-shaped guide hole is located at higher position of the barrel, and

FIG. 13 shows a conventional positioning device of electric nailers.

### DETAILED DESCRIPTION OF THE PREFERRED EMBODIMENT

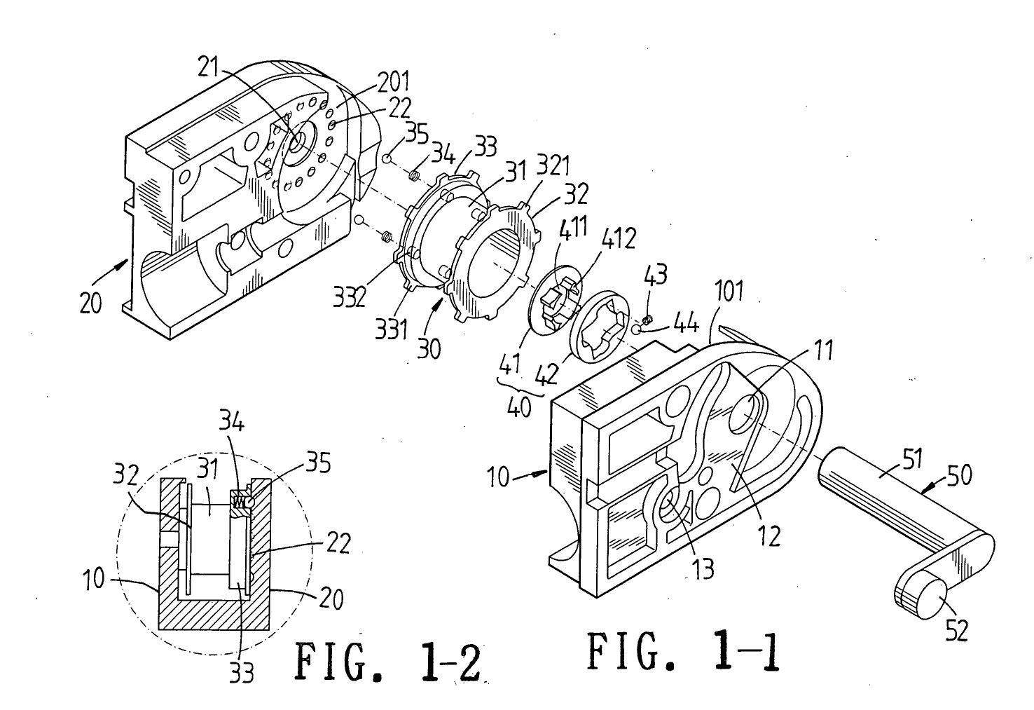

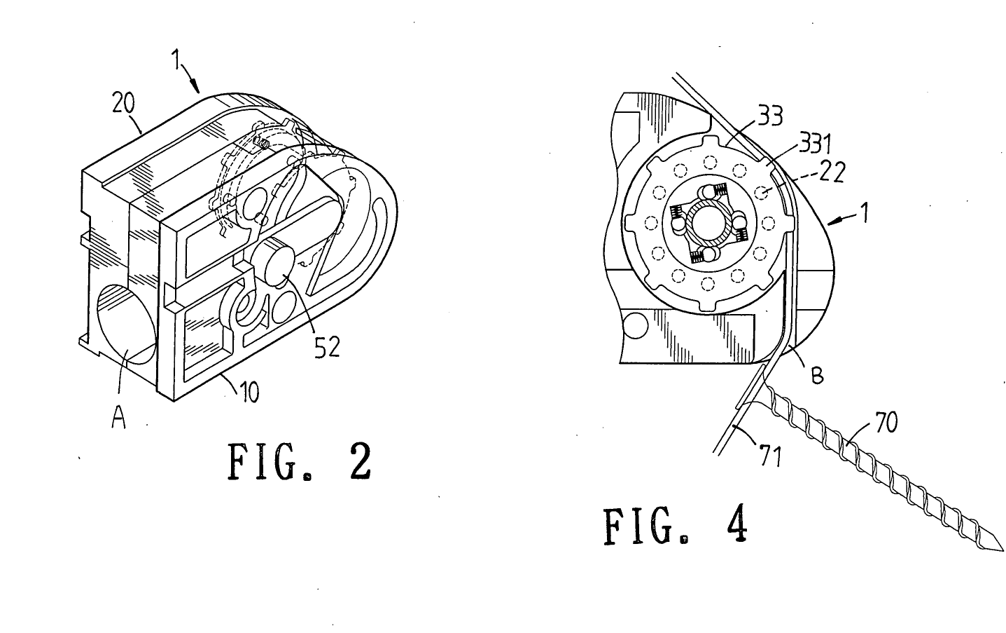

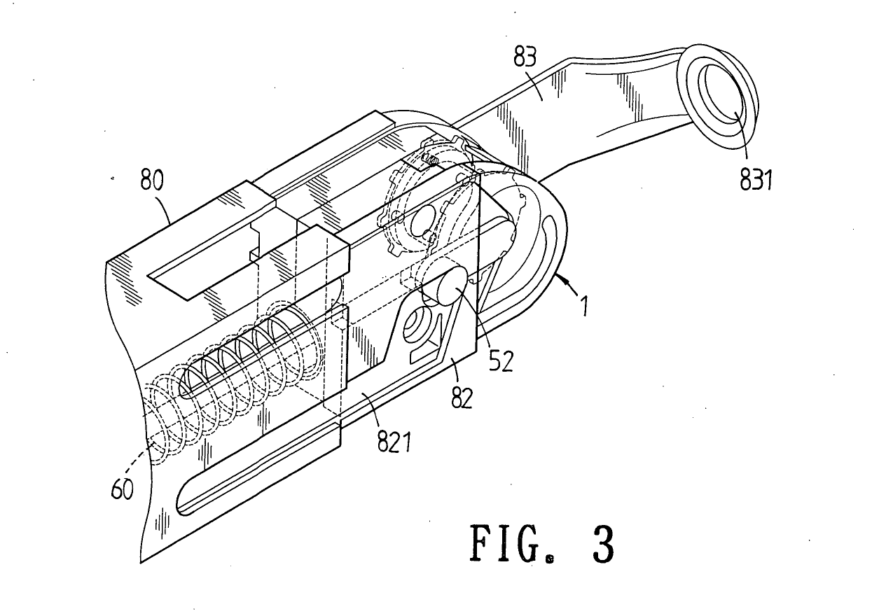

Referring to FIGS. 1-1, 1-2, 2, 3 and 4, the positioning device 1 of the present invention comprises a case composed of a first part 10 and a second part 20 which is connected to the first part 10 by extending bolts or rivets (not shown) through the connection hole 13 in the first part 10 and another connection hole in the second part. The first part 10 includes a receiving space 101 and the second part 20 includes another receiving space 201 so that a driving member 30 is received in the combined receiving spaces 101, 201 of the case. Each of the first part 10 and the second part 20 includes a semi-circular recess so as to form a receiving chamber “A” (FIG. 2) for receiving an end of a spring 60 therein. The end having the receiving chamber of the case is movably received in a barrel 80 composed of two side walls 82 so that the spring 60 is biased between the end of the case and an inside of the barrel 80.

The driving member 30 is an I-shaped member and has two disks 32, 33 on two ends of a shaft 31 of the driving member 30 and each disk 32/33 has a plurality of teeth 321/331 extending radially outward from an outer periphery thereof so as to be engaged with a nail chain 71 on which nails 70 are connected. The nail chain 71 can be inserted into the case via a slot “B” (FIG. 4). The disk 33 has at least one recess 332 defined in an outside thereof, and a spring 34 and a bead 35 are respectively received in the at least one recess 332. The second part 20 has a plurality of positioning dents 22 defined in an inside thereof so that the bead 35 is engaged with one of the dents 22.

A crank member 50 has a plate and a first protrusion 51 and a second protrusion 52 extend from two opposite sides of the plate. The first protrusion 51 extends through a first hole 11 in the first part 10, a one-direction bearing 40 in a central passage defined through the driving member 30, and a second hole 21 defined through the second part 20. The dents 22 are located around the second hole 21. One of the two side walls has an L-shaped guide hole 821 and the second protrusion 52 is movably engaged with the L-shaped guide hole 821.

The one-direction bearing 40 includes a first circular disk 41 and a second circular disk 42. A plurality of brace members 412 extend from a side of the first circular disk 41 and a plurality of concavities are defined in the second circular disk 42. Each concavity has a spring 43 and a roller 44 received therein, the rollers 44 are respectively braced by the brace members 412.

The first part 10 includes a fan-shaped recessed area 12 and the first hole 11 is located in the recessed area 12. The plate of the crank member 50 is movably retained in the recessed area 12 so that the plate is pivoted between two end walls of the recessed area 12.

A safety link 83 has one end connected to the case and located between the case and the barrel 80. The other end of the safety link 83 includes a ring with a hole 831.

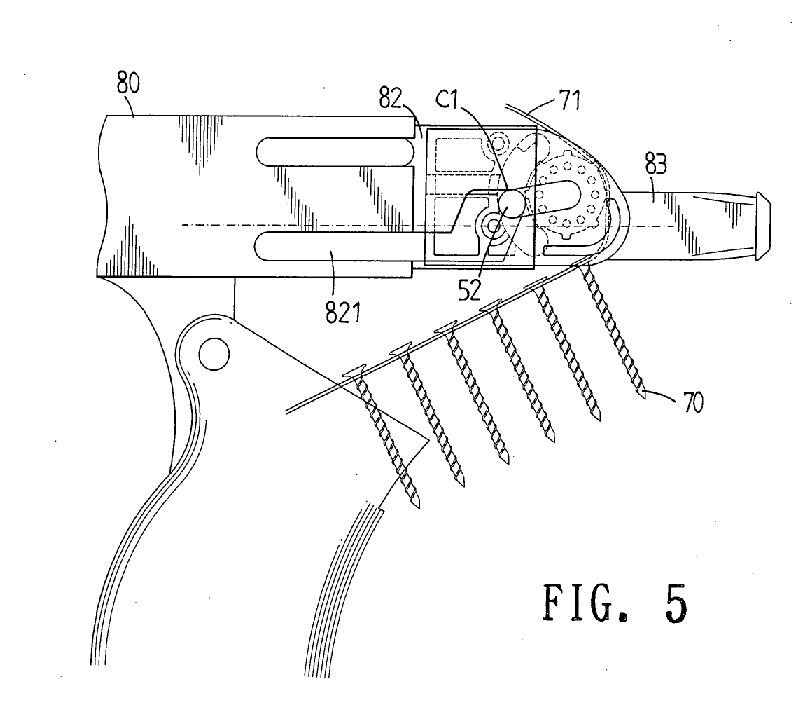

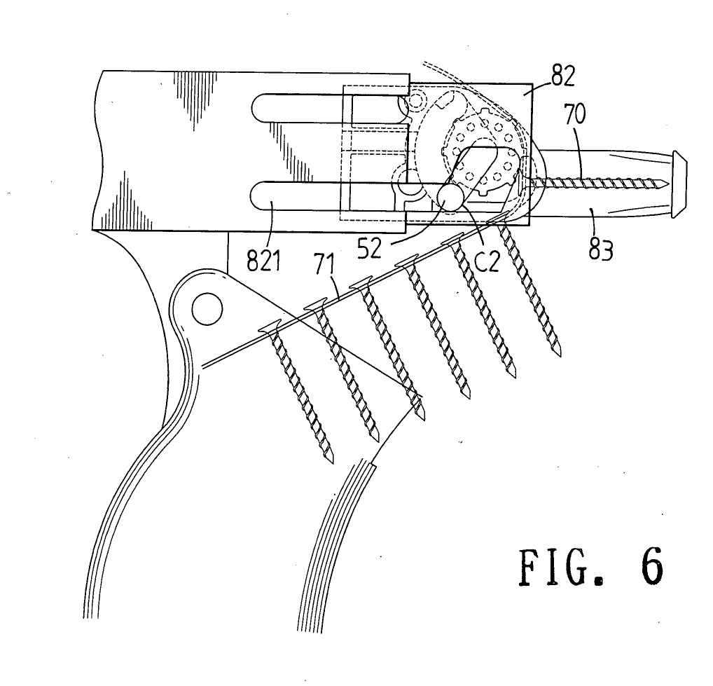

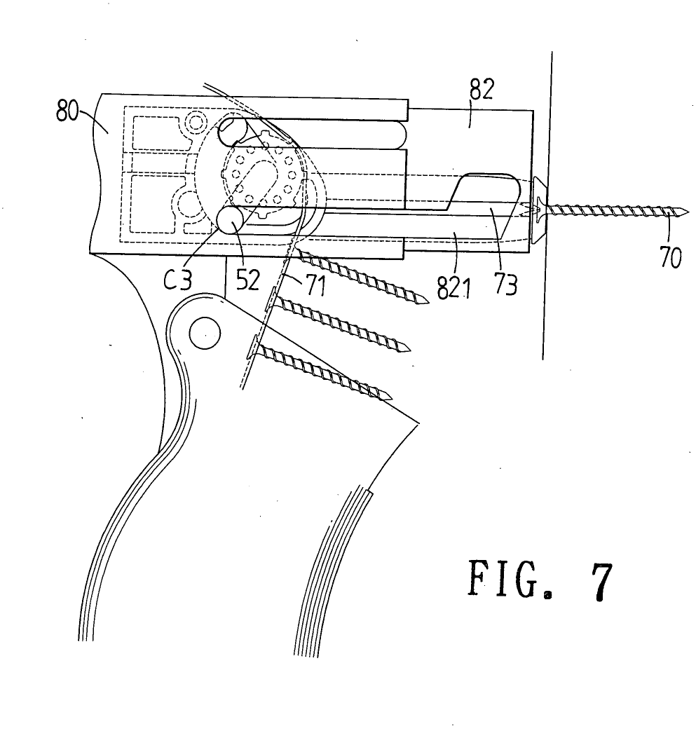

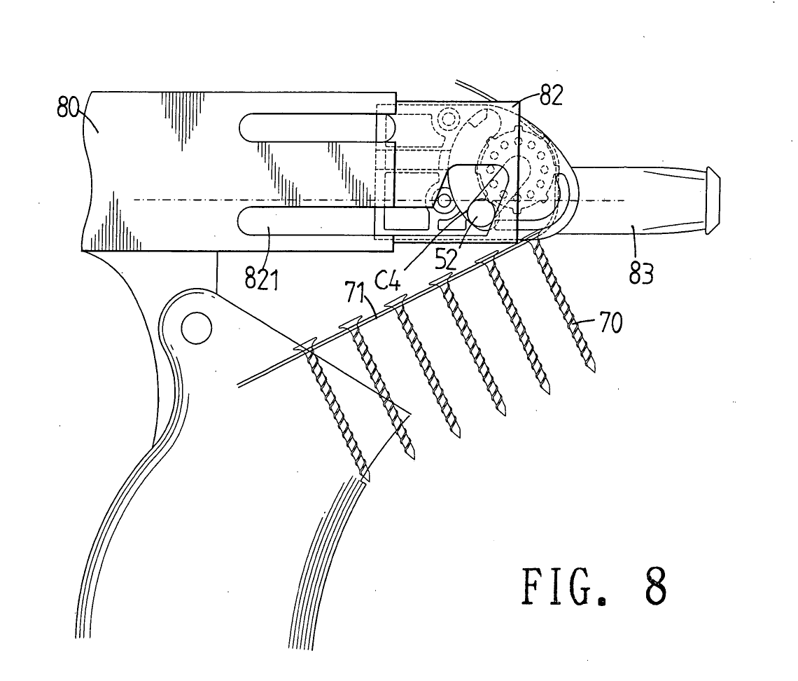

Referring to FIGS. 5 to 8, when using the nailer, the safety link 83 is pushed against an object, the safety link 83 and the case are pushed toward the barrel 80, the position of the second protrusion 52 is then moved from one inside end in the L-shaped hole 821 to the position “C1” as disclosed in FIG. 5. The movement of the second protrusion 52 rotates the driving member 30 and the bead 35 is moved from one dent 22 to another, the nail chain 71 is pulled so that one nail 70 is in aligned with the hole 831 in the ring. Keeping pushing the safety link 83, the second protrusion 52 moves to the other inside end of the L-shaped guide hole 821 at position C3 as shown in FIG. 7. The nail 70 is nailed into the object by a power bit in the nailer BY triggering the nailer. When removing the safety link 83 away from the object, the spring 60 pushes the case back and the second protrusion 52 moves to the initial position as shown in FIG. 8.

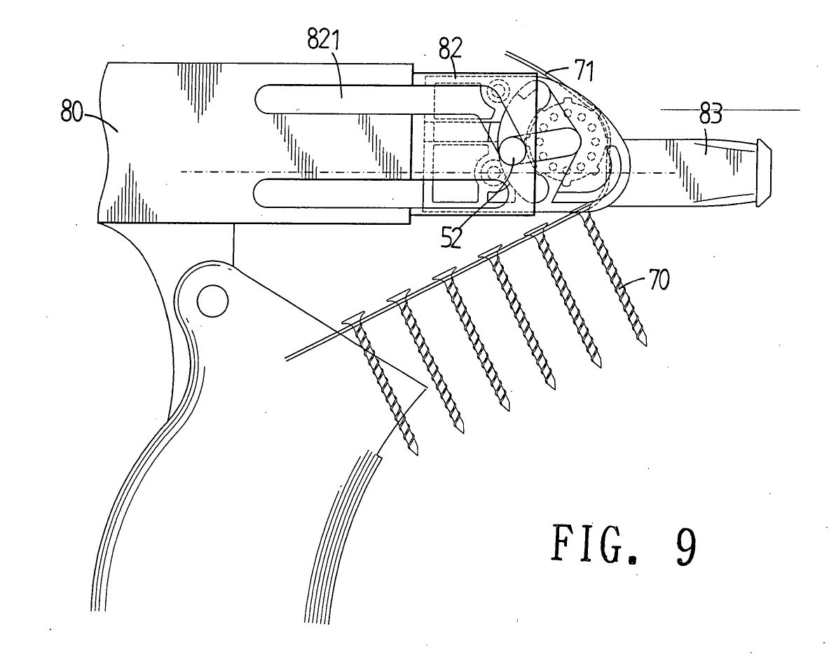

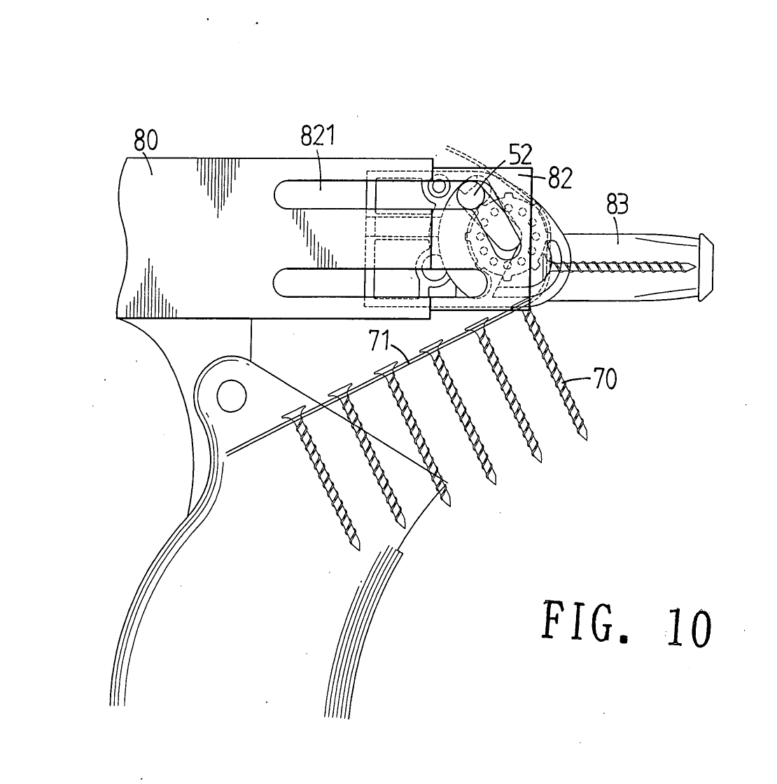

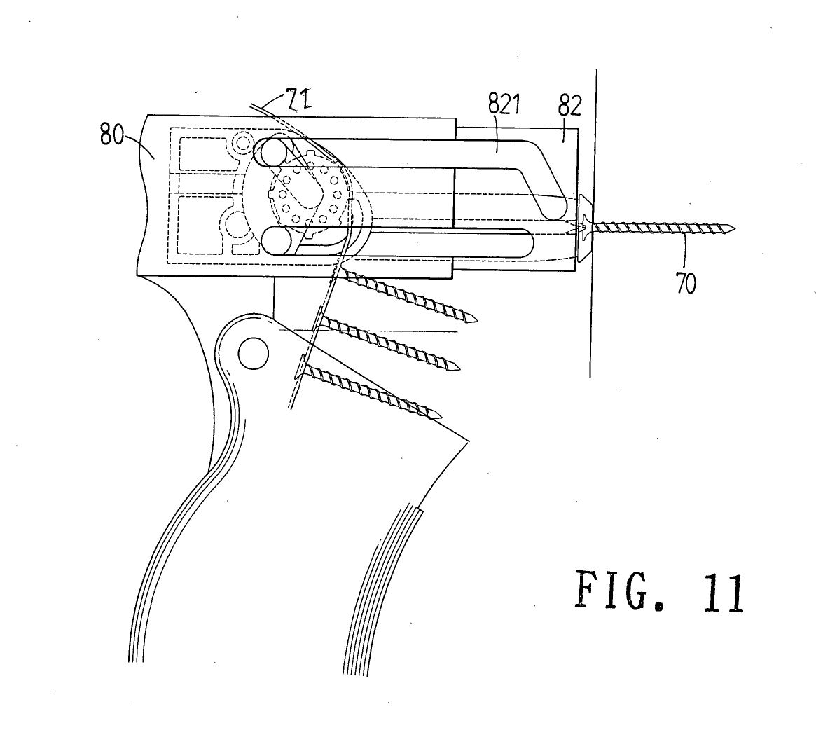

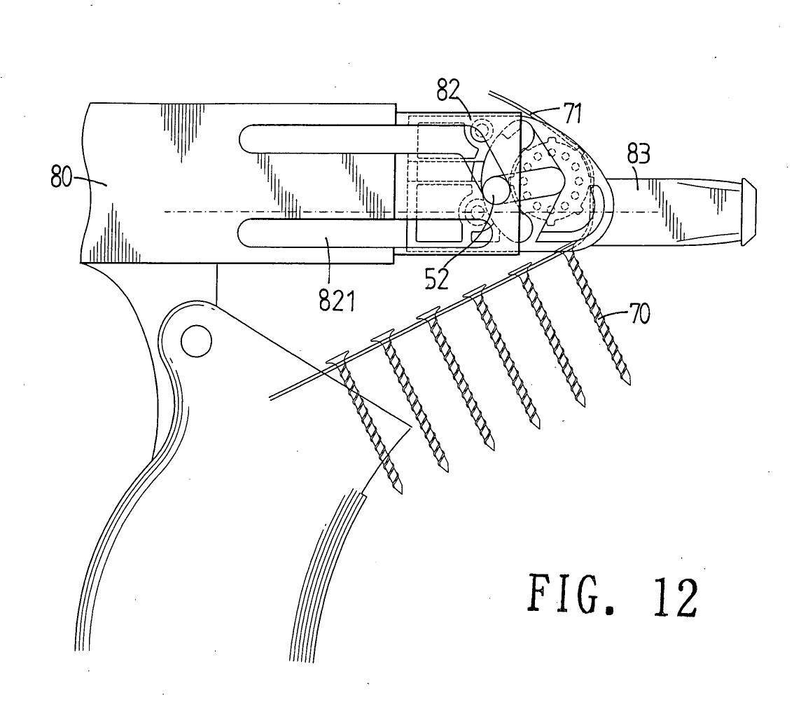

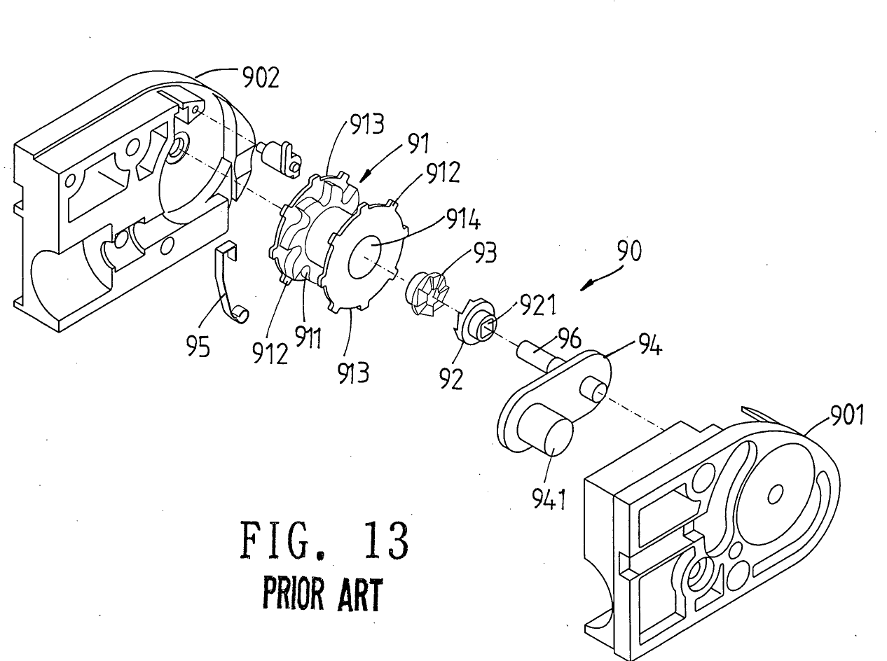

FIGS. 9 to 12 show another embodiment of the present invention wherein the L-shaped guide hole 821 is located at higher position of the barrel. This can be done by reversing the side wall of the barrel 80. The L-shaped guide hole 821 includes a horizontal section and an inclined section, both sections have the same width, which allows the user to control the speed of movement of the second protrusion 52. The position of the L-shaped guide hole 821 allows the user to connect the safety link 83 as desired side of the barrel.

The driving member 30 can be easily made to be a one-piece member without complicated machining processes and the positioning of the driving member 30 is achieved by engaging the bead 35 with the dents 22 so as to improve the shortcomings of the conventional device.

While we have shown and described the embodiment in accordance with the present invention, it should be clear to those skilled in the art that further embodiments may be made without departing from the scope of the present invention.

What is claimed is:

1. A positioning device comprising:
a case composed of a first part and a second part, an end of the case being movably received in a barrel composed of two side walls, a driving member received between the first part and the second part, the driving member adapted to be engaged with a nail chain, two disks on two ends of a shaft of the driving member, one of the disks having at least one recess defined in an outside thereof, a spring and a bead respectively received in the at least one recess, the second part having a plurality of positioning dents defined in an inside thereof so that the bead is engaged with one of the dents;
a crank member having a first protrusion extending through a first hole in the first part, a one-direction bearing in a central passage defined through the driving member, and a second hole defined through the second part, the dents located around the second hole, and a spring being biased between the case and the barrel.

2. The device as claimed in claim 1, wherein the crank member includes a plate and the first protrusion extends from one of two opposite sides of the plate, a second protrusion extends from the other of the two opposite sides of the plate, one of the two side walls has an L-shaped guide hole and the second protrusion is movably engaged with the L-shaped guide hole.

3. The device as claimed in claim 2, wherein the one-direction bearing includes a first circular disk and a second circular disk, a plurality of brace members extend from a side of the first circular disk, a plurality of concavities are defined in the second circular disk and each concavity has a spring and a roller received therein, the rollers are respectively braced by the brace members.

4. The device as claimed in claim 2, wherein the first part includes a fan-shaped recessed area and the first hole is located in the recessed area, the plate of the crank member being movably retained in the recessed area so that the plate is pivoted between two end walls of the recessed area.

5. The device as claimed in claim 1, wherein a safety link has one end connected to the case and located between the case and the barrel.

6. The device as claimed in claim 5, wherein the other end of the safety link includes a ring with a hole.

7. The device as claimed in claim 1, wherein the case has a receiving chamber defined in an end thereof and the spring has one end received in the receiving chamber.

8. The device as claimed in claim 1, wherein each disk of the driving member has a plurality of teeth extending radially outward from an outer periphery thereof so as to be adapted to engage with the nail chain.

9. The device as claimed in claim 2, wherein the L-shaped guide hole includes a horizontal section and an inclined section, both sections have the same width.
